(19) United States
(12) Patent Application Publication
(10) Pub. No.: US 2020/0388032 A1
(43) Pub. Date: Dec. 10, 2020

(54) THREE DIMENSIONAL HISTOPATHOLOGY IMAGING METHOD AND SYSTEM THEREOF

(71) Applicant: JelloX Biotech Inc., Hsinchu City (TW)

(72) Inventors: Ann-Shyn Chiang, Hsinchu City (TW); Dah-Tsyr Chang, Hsinchu City (TW); I-Ching Wang, Hsinchu City (TW); Jia-Ling Yang, Hsinchu City (TW); Shun-Chi Wu, Hsinchu City (TW); Yen-Yin Lin, Hsinchu City (TW); Yu-Cheih Lin, Hsinchu City (TW)

(21) Appl. No.: 16/891,101

(22) Filed: Jun. 3, 2020

Related U.S. Application Data
(60) Provisional application No. 62/856,741, filed on Jun. 4, 2019.

(51) Int. Cl. G06T 7/00; G01N 1/30; G01N 1/36; G02B 21/36; G06T 15/08

(52) U.S. Cl. CPC G06T 7/0012; G01N 1/30; G01N 1/36; G02B 21/365; G06T 2210/41; G06T 2207/10056; G06T 2207/30061; G06T 2207/30084; G06T 2207/30024; G06T 15/08

(57) ABSTRACT

The invention provides a 3D histopathology imaging method. The method includes collecting a tissue specimen from a subject, staining the tissue so as to obtain a stained tissue, obtaining, by a microscopy, a 3D image of the stained tissue, and performing an image slicing procedure on the 3D image to generate a plurality of 2D images.

### CROSS REFERENCE TO RELATED APPLICATION

The present application claims priority to U.S. Provisional Application Ser. No. 62/856,741, filed on Jun. 4, 2019, which are hereby incorporated by reference in their entirety.

### FIELD

This invention relates to an imaging system and an imaging method, and more particularly, to a three dimensional (3D) histopathology imaging system, and a 3D histopathology imaging method.

### BACKGROUND

Histopathology refers to microscopic examination of tissue in order to study the manifestations of disease. Histopathology can be more definitely defined in clinical medicine, that histopathology refers to the examination of a biopsy or surgical specimen by a pathologist, after the specimen has been processed and histological sections have been placed onto glass slides.

3D histopathology image involves the use of current technologies, such as microscopy and computer imaging systems, to facilitate examinations. FIG. 1 illustrates one of the traditional techniques for obtaining a 3D histopathology imaging system. As shown in FIG. 1, a tissue is obtained through biopsy. The tissue may be lung or kidney tissue. The tissue is next performed with a so called Formalin-Fixed Paraffin-Embedded (FFPE) process to form a tissue block. The tissue block is then cut into slices, each being about 3-5 um in thickness. Each slice is then stained, and a microscopy is utilized to image the slices and to generate 2D images of each slice. These 2D images will be sent to and processed by a computer. The computer gathers and processes the 2D images, and reconstructs a 3D image from the 2D images. This traditional technique however exhibits a 2 um image loss between two 2D images, since the tissue was sliced into pieces at the beginning.

FIG. 2 illustrates another traditional technique for obtaining a 3D histopathology imaging. Likewisely, a tissue is obtained through biopsy, but the tissue is next stained and embedded in paraffin to form a tissue block. The ensuing slicing process, 2D imaging and 3D reconstructing processes are alike to those as described in FIG. 1 and are thus omitted for relevant descriptions. Though the effectiveness of this technique is improved a bit, it however still exhibits a 1-2 um image loss between two 2D images, and that image loss is also attributable to the slicing process.

Accordingly, how to reduce the image loss is still a pending problem that needs to be solved.

### SUMMARY OF THE DISCLOSURE

One of the purposes of the present invention is to provide a 3D histopathology imaging method capable of reducing image losses.

Yet another purpose of the present invention is to provide a 3D histopathology imaging method that facilitate medical staffs on therapeutic decisions.

The 3D histopathology imaging method of the present invention includes the following steps of collecting a tissue specimen from a subject, staining the tissue so as to obtain a stained tissue, obtaining, by a microscopy, a 3D image of the stained tissue, performing an image slicing procedure on the 3D image to generate a plurality of 2D images.

Preferably, the step of staining the tissue further comprises embedding the stained tissue in an agarose gel or a hydrogel.

Preferably, the method further comprises a tissue clearing procedure after the step of collecting the tissue specimen.

Preferably, the microscopy performs a laser scan procedure to obtain the 3D image.

Preferably, the image slicing procedure slices the 3D image into different planes to generate a plurality of 2D sliced images.

Preferably, the plurality of 2D images presents an antibody expression.

Preferably, the 3D image is sliced along an X-axis, a Y-axis and a Z-axis.

The other purpose of the present invention is to provide a 3D histopathology imaging system, which is a system that is capable of reducing image losses.

Yet another purpose of the present invention is to provide a 3D histopathology imaging system that facilitate medical staffs on therapeutic decisions.

The 3D histopathology imaging system includes a microscopy and a processor. The microscopy is configured to obtain a 3D image of a tissue specimen, and the processor is configured to perform an image slicing procedure on the 3D image to generate a plurality of 2D images. The tissue specimen is collected from a subject, and the collected tissue is stained and embedded.

Preferably, the stained tissue is further embedded in an agarose gel or a hydrogel.

Preferably, the collected tissue is treated with a tissue clearing procedure.

Preferably, the microscopy performs a laser scan procedure to obtain the 3D image.

Preferably, the image slicing procedure slices the 3D image into different planes to generate a plurality of 2D sliced images.

Preferably, the plurality of 2D images presents an antibody expression

Preferably, the 3D image is sliced along an X-axis, a Y-axis and a Z-axis.

### BRIEF DESCRIPTION OF THE DRAWINGS

The present invention will be apparent to those skilled in the art from the following detailed description of the preferred embodiments, with reference to the attached drawings, in which:

FIG. 1 illustrates one of the traditional techniques for obtaining a 3D histopathology imaging system;

FIG. 2 illustrates another traditional technique for obtaining a 3D histopathology imaging system;

FIG. 3 is a flowchart illustrating the steps of the 3D histopathology imaging method of the present invention;

FIGS. 4(a) and 4(b) illustrate virtual slicing of 3D images viewed at different viewing plane;

FIG. 5(a) is a schematic view demonstrating a 3D human lung tissue sample labeling with thyroid transcription factor 1 (TTF-1) antibody and counterstain;

FIG. 5(b) is a schematic view illustrating the antibody expression densities at different plane;

FIG. 5(c) is the maximum TTF-1 expression slice extract from the XY slicing plane;

FIG. 5(d) is the maximum TTF-1 expression slice extract from the YZ slicing plane; and

FIG. 6 is a schematic view illustrating a 3D histopathology imaging system according to an embodiment of the present invention.

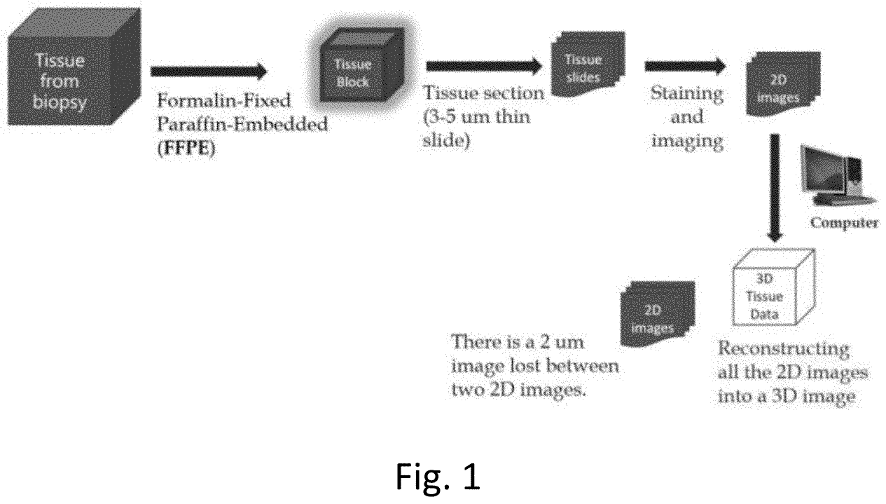

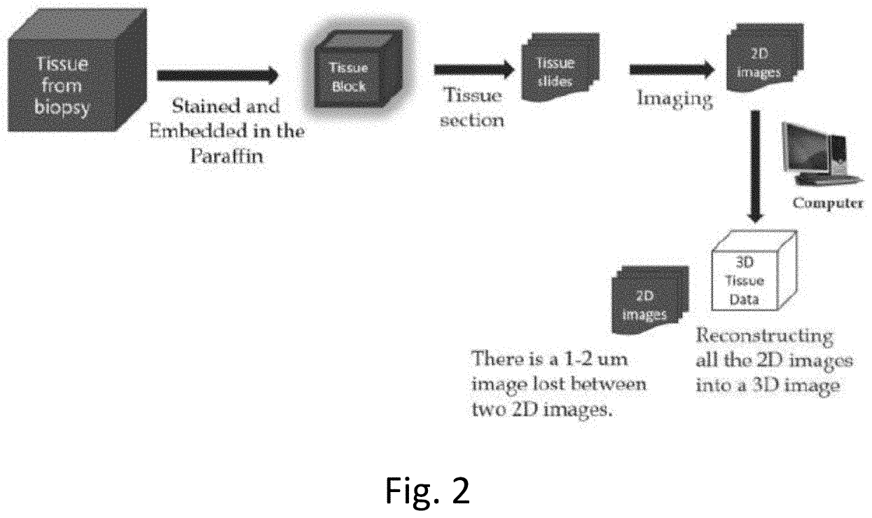

### DETAILED DESCRIPTION

Unless defined otherwise, all technical and scientific terms used herein have the same meanings as commonly understood by one of skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

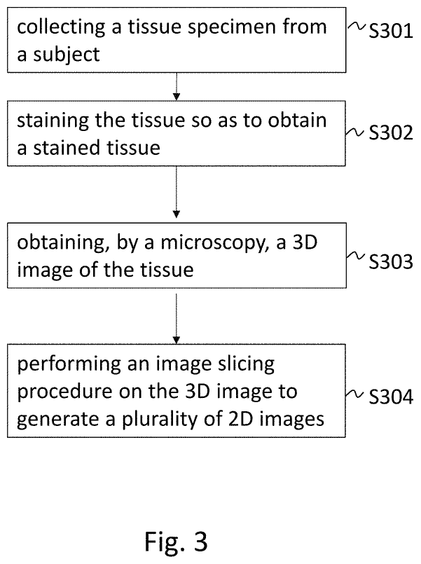

Reference is made to FIG. 3, which is a flowchart illustrating the steps of the 3D histopathology imaging method of the present invention. Referring to step S301, collecting a tissue specimen from a subject. The tissue specimen may be a lung tissue, a kidney tissue, a breast tissue, or tissues from other organs. The scope of the present invention should not be limited by the origin of the tissue. The subject may be a living body, such as a human body. Collecting a tissue specimen may be done by performing a biopsy process, and this biopsy process may be performed in any sort. Biopsy may be referred to as an examination of tissue removed from a living body to discover the presence, cause, or extent of a disease, and that the biopsy referred to in step S301 is not limited to any sort.

Next, in step S302, staining the tissue so as to obtain a stained tissue. In step S302, the collected tissue is stained with, but not limited to, dyes such as haematoxylin and eosin (H&E), to prepare a stained tissue. The stained tissue may further be embedded in an agarose gel or a hydrogel. The embedding may provide physical support for specimen during tissue clearing and labeling. In an embodiment, the hydrogel is an agarose gel prepared from a warm aqueous solution containing 1-4% w/w agarose. In another embodiment, the hydrogel is prepared from a water dispersion of at least one natural or synthetic polymer which solidifies upon change in temperature, pH, salts, or irradiation. Examples of said polymer includes alginate, hyaluronates, and acrylamide-based polymers.

One should note that the foregoing tissue clearing may not be a necessary step in the present invention. However, if tissue clearing is performed, it may be performed after the step of collecting a tissue specimen from a subject (as in S301) and before the step of staining the tissue (as in S302). One of the purposes for tissue clearing is that clearing may contribute to a much clearer image, or may provide images with higher resolution. However, tissue clearing is not be required in the present invention.

Next in step S303, obtaining, by a microscopy, a 3D image of the tissue. In step S303, laser scan technology is applied for obtaining a microscopy, and the tissue is not physically sectioned into pieces when scanning. It can be further understood that the tissue is scanned through laser scan technology right after tissue staining and embedding, and that the scanning is performed on an intact tissue block. In other words, the tissue block is not sliced into pieces before laser scanning. Other scanning technologies may also be applied in the present invention to obtain a 3D image from the unsliced tissue, therefore the scope of the present invention should not be limited to laser scan technology only.

Since the tissue scanned by the microcopy is not sliced into pieces, image losses may be reduced in the present three-dimensional histopathology imaging method.

Next in step S304, performing an image slicing procedure on the 3D image to generate a plurality of 2D images. The image slicing procedure may be a virtual slicing procedure. The 2D image slices are generated by virtual slicing, to slice the 3D image into multiple virtual slices. Each image slice may be displayed on a monitor as a conventional 2D image showing a cross-sectional view of the imaged tissue specimen. The 3D image is virtually sliced along an X-axis, a Y-axis and a Z-axis. After image slicing along the three axes, a batch of 2D images (i.e., multiple 2D images on XY-plane, YZ-plane and XZ-plane) along the X-axis, Y-axis and Z-axis are obtained.

The X-axis, Y-axis and Z-axis may be construed as a Euclidean space, and that the 3D image is a vector in the Euclidean space. The 3D image is virtually sliced along the three axes to generate a plurality of 2D images on the XY-plane, YZ-plane and XZ-plane. The directions for the X-axis, Y-axis and Z-axis are not restricted, as long as the X-axis, Y-axis and Z-axis are perpendicular to each other. In other words, the X-axis, Y-axis and Z-axis collectively form an orthogonal set (each is a unit vector) that forms the Euclidean space. Therefore, the orthogonal set can be rotated arbitrarily.

Referring back to step S304, the 3D image is sliced into different plane to generate multiple 2D images with profiles of features thereon. The profiles of features may be such as antibody expression profile, or other biological features, and the statistics result of the features would be defined from these multiple profiles. The image slicing is based on virtual slicing. Since virtual image slicing is well known in the image processing field, the one with ordinary skill in the art will understand the process, relevant descriptions regarding virtual image slicing will be omitted for convenience.

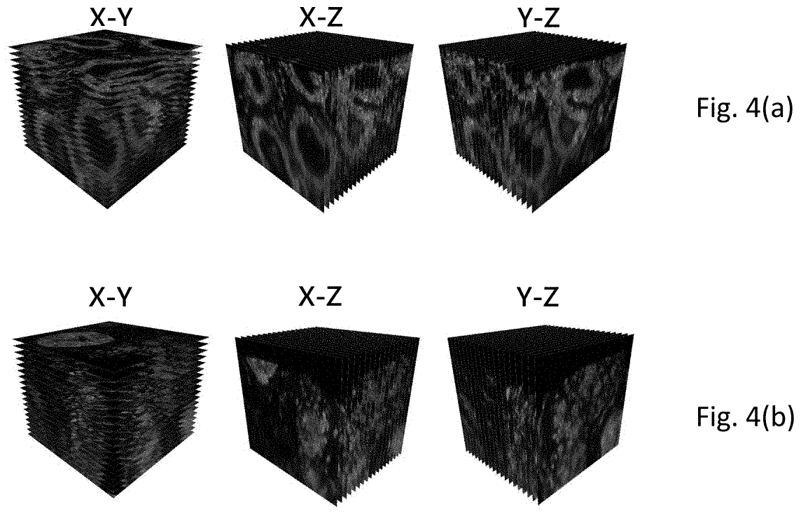

Human tissue, especially tumor/cancer tissue, is heterogeneous. Heterogeneity makes human tissue looks differently at different viewing plane. Reference is collectively made to FIGS. 4(a) and 4(b), which illustrating virtual slicing of 3D images viewed at different viewing plane. In FIGS. 4(a) and 4(b), breast tissue is taken as an exemplary purpose for tissue specimen collection and the following 3D scanning image for virtual slicing. However, virtual slicing should not be construed to be limiting to breast tissue only. FIG. 4(a) illustrates a normal breast tissue, and from left to right, FIG. 4(a) displays a normal breast tissue viewed respectively from XY-, XZ- and YZ-plane. FIG. 4(b) illustrate a breast cancer tissue, and also from left to right, FIG. 4(b) displays a breast cancer tissue viewed also respectively from XY-, XZ- and YZ-plane.

It can be seen in FIG. 4(b) that the cancer tissue exhibits the foregoing heterogeneity property. The breast cancer tissue looks differently when viewing from XY-, XZ- and YZ-plane. Comparing to FIG. 4(a), a normal breast tissue looks much consistent among XY-, XZ- and YZ-plane viewings.

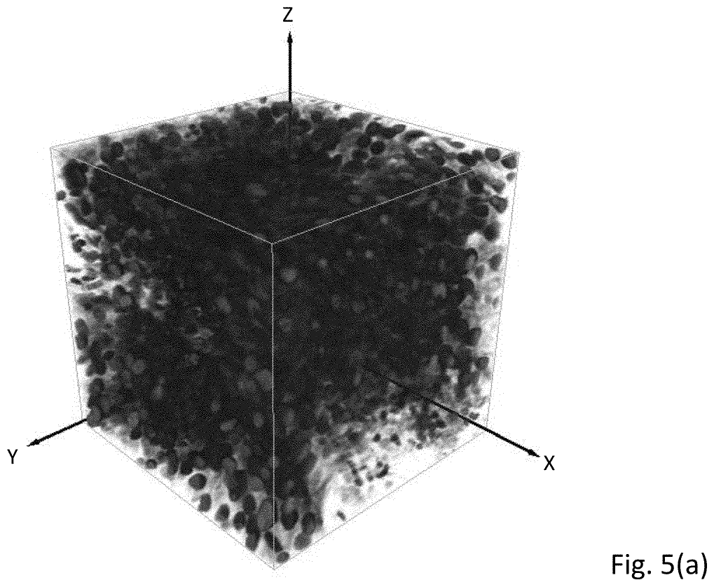

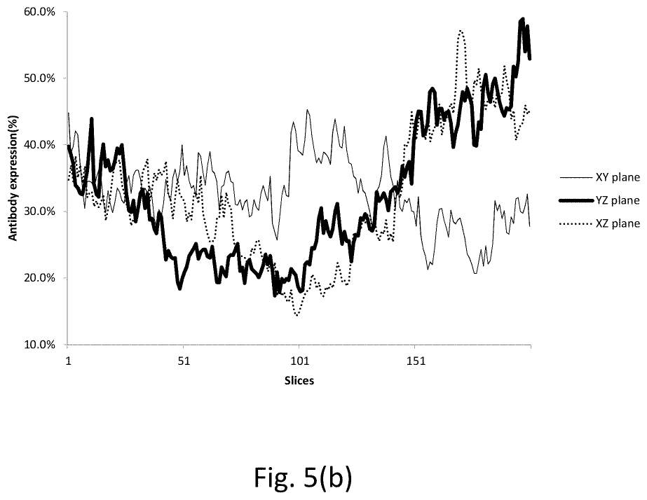

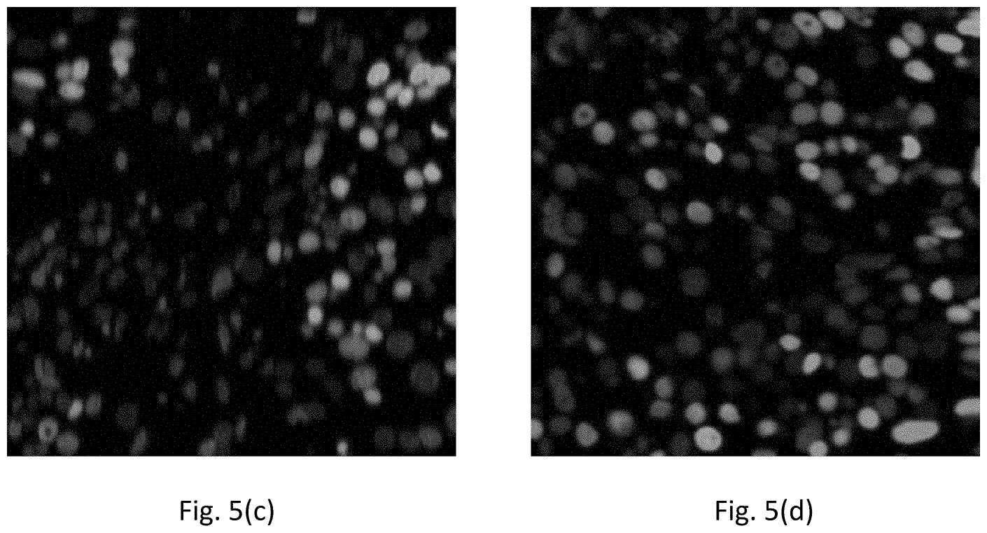

Reference is next made to FIG. 5(a), which demonstrates a 3D human lung tissue sample labeling with thyroid transcription factor 1 (TTF-1) antibody and counterstain. TTF-1 is labeled in green, and the counterstain is labeled in red and blue. TTF-1 is routinely applied in the diagnostic evaluation of suspected lung cancers as a predictive and prognostic marker. The expression level of TTF-1 may be graded in four grades as: Grade 1, 6% to 25% of tumor cells positive; Grade 2, 26% to 50% of tumor cells positive; Grade 3, 51% to 75% of tumor cells positive; and Grade 4, more than 76% of tumor cells positive.

To accurately calculate the diagnosis features such as antibody expression density or tumor region accurately in a 3D image, a straight forward approach is to adopt the algorithm for 3D imaging, such as 3D Convolutional Neural Network. However, to execution of such algorithms involves expensive computing infrastructure, which limits the application of 3D analysis. Moreover, these algorithms only detect certain features in a 3D image, they cannot extract the most representative 2D images that are deemed as the current gold standard in pathological diagnosis for pathologist to confirm the result. Therefore, analyzing serial 2D images instead of analyzing 3D image is a much appropriate method in the field.

The 3D lung tissue image in FIG. 5(a) is then virtually sliced into a batch of 2D images respectively at XY-, XZ- and YZ-plane, and antibody expression densities are calculated with respect these 2D imaged. The calculated antibody expression densities at different plane can be seen in FIG. 5(b), and the statistic results are demonstrated in the following Table 1. FIG. 5(b) is a schematic view illustrating the antibody expression densities at different plane. The average antibody expression density is similar at each slicing plane, but the difference of maximum antibody expression density between each slicing planes reveals the heterogeneous of tumor tissue.

TABLE 1

| | XY plane | YZ plane | XZ plane |
|---|---|---|---|
| Average antibody expression (%) | 32.7% | 32.4% | 32.5% |
| Maximum antibody expression slice | 104 | 197 | 170 |
| Cell counts at maximum antibody | 102/173 | 63/139 | 87/152 |
| expression slice | | | |
| (antibody positive cells/total cells) | | | |
| Maximum antibody expression (%) | 45.3% | 59.0% | 57.2% |

Referring collectively to FIGS. 5(c) and 5(d), where FIG. 5(c) is the maximum TTF-1 expression slice extract from the XY slicing plane, and FIG. 5(d) is the maximum TTF-1 expression slice extract from the YZ slicing plane. These extracted images are then further confirmed by pathologists in visual inspection for diagnosing the TTF-1 expression level in this specimen.

In sum, the 3D imaging method of the present invention may be further viewed as a histopathology imaging method, and it obtains a 3D image of a collected tissue specimen without slicing the specimen, applies virtual image slicing on the 3D image along three mutually perpendicular axes (e.g., the X-axis, Y-axis and Z-axis of a Euclidian space) to generate a plurality 2D images on each axis, and calculate a profile of feature (e.g., the antibody expression of the present invention) of each 2D image.

Without segmenting the tissue block, it can be expected that less, even no, image losses may be achieved. Further, the antibody expressions calculated from the 2D images with respect to each axis provides information for medical staffs, from them to determine a proper therapeutic approach for a patient. For example, a tissue specimen is collected from a patient with breast cancer. The breast tissue is performed with the 3D histopathology imaging method of the present invention, and thus a plurality 2D images along the X-axis, Y-axis and Z-axis are obtained, with the antibody expressions with respect to the three axis are also obtained.

A doctor may rely on the antibody expressions to determine what therapeutic approached should be taken to treat the patient. For example, the expression level of HER2 antibody is a prerequisite when considering a patient's eligibility for Herceptin (trastuzumab) therapy. Accurate assessment of HER2 status is critical to ensure that patients who may benefit from Herceptin target therapy are identified. There are plenty of antibodies used in diagnostic surgical pathology. Many clinical laboratories and hospitals maintain menus of over 200 antibodies used for clinical diagnostic, prognostic and predictive biomarkers, and many of the antibodies are applied on cancer diagnosis.

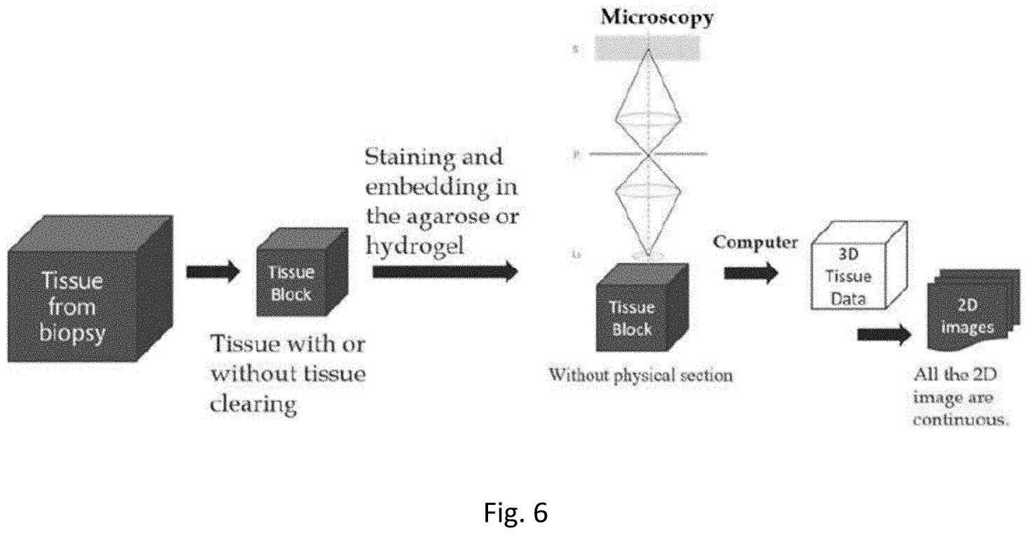

Reference is next made to FIG. 6, which is a schematic view illustrating a 3D histopathology imaging system according to an embodiment of the present invention. Firstly, a tissue specimen is collected from a subject. The tissue may be a lung tissue, a kidney tissue, a breast tissue, or tissues from other organs. The subject of the present embodiment may be a living body, such as a human body. Collecting a tissue specimen may be done by performing a biopsy process, and this biopsy process may be performed in any sort. Biopsy may be referred to as an examination of tissue removed from a living body to discover the presence, cause, or extent of a disease.

The tissue is next stained. The stained tissue is then embedded in an agarose gel or a hydrogel. Staining the tissue involves staining the tissue with dyes such as haematoxylin and eosin (H&E), and embedding the stained tissue in agarose gel or hydrogel may provide physical support for specimen during tissue clearing and labeling. In an embodiment, the hydrogel is an agarose gel prepared from a warm aqueous solution containing 1-4% w/w agarose. In another embodiment, the hydrogel is prepared from a water dispersion of at least one natural or synthetic polymer which solidifies upon change in temperature, pH, salts, or irradiation. Examples of said polymer include alginate, hyaluronates, and acrylamide-based polymers.

An extra tissue clearing step may be taken in some situations, and this tissue clearing step may be done after the tissue specimen is collected and before staining and embedding the tissue specimen. Tissue clearing involves using clearing agent to clear up the tissue. Clearing agent may be, but limited to, aqueous clearing agent. In the present invention, the aqueous clearing agent used for tissue clearing has a refractive index ranges of 1.33-1.55. Preferable, the index is between 1.40-1.52, and more preferably, between 1.45-1.52. The aqueous clearing agent may include an ingredient selected from the group consisting of glycerol, histodenz, formamide, triethanolamine, meglumine diatrizoate, and combinations thereof.

Treatment with such aqueous clearing agent, which takes no more than 12 hours, causes a tissue specimen with a thickness of at least 200 μm to become sufficiently transparent while preventing tissue shrinkage or deformation and eliminating lipid removal. Since the structural integrity of the cleared tissue specimen is well preserved, the microscopic images obtained thereafter will provide more accurate morphological information.

The stained and embedded tissue is then laser scanned by a microscopy, to generate a 3D image of the tissue. The tissue is directly scanned, without being sliced into sections. Understandably, slicing a tissue block into several segments means a continuous tissue block is cut (or sliced, or segmented) into several discrete slices. Without slicing the tissue, the generated 3D image maintains it continuity as a continuous image, which further means less image losses can be expected.

A processor may be used to capture and/or receive the 3D tissue image resulted from the microscopy, for further processing the data and information carried in the 3D tissue image. Next, a slicing procedure is performed on the 3D tissue image to generate a plurality sets of 2D images. The 2D image slices are generated by virtual slicing, usually sliced in the depth or z direction of a 3D image, to slice the 3D image into multiple virtual slices. Each image slice may be displayed on a monitor as a conventional 2D image showing a cross-sectional view of the imaged tissue specimen.

The processor may be a microprocessor, a microcontroller, or a CPU. The processor is not limited to any form. A device that is capable of performing computer instructions may be suitable for the role of processor in the present invention. The processor may be included in a computer, which further includes memory units for storing computer instructions.

Similar to the descriptions above, the 3D image of the present embodiment is also virtually sliced along an X-axis, a Y-axis and a Z-axis. After image slicing along the three axes, a plurality of 2D images (i.e., multiple 2D images on the XY-plane, YZ-plane and XZ-plane) along the X-axis, Y-axis and Z-axis are obtained.

The X-axis, Y-axis and Z-axis may be construed as a Euclidean space, and that the 3D image can be viewed as a vector in the Euclidean space. The 3D image is virtually sliced along the three axes to generate a plurality of 2D images on the XY-plane, YZ-plane and XZ-plane. The directions for the X-axis, Y-axis and Z-axis are not restricted, as long as the X-axis, Y-axis and Z-axis are perpendicular to each other. That is to say, as long as the three are mutually perpendicular to each other, the three axes can be rotated for any angle. Arbitrary rotation for the three basis that from a space plays no role to the outcome.

Similar to the previously addressed embodiment, the 2D images along the three axes are calculated with the antibody expressions of each of the 2D images. The antibody expressions along the three axes provide information to medical staffs to rely on, to provide patient with proper therapeutic approaches. For example, a tissue specimen is collected from a patient with lung cancer. The lung tissue is performed with the 3D histopathology imaging method of the present invention, and thus a plurality 2D images along the X-axis, Y-axis and Z-axis are obtained, with the antibody expressions with respect to the three axis are also obtained.

A doctor may rely on the antibody expressions to determine what therapeutic approached should be taken to treat the patient. For example, the expression level of HER2 antibody is a prerequisite when considering a patient's eligibility for Herceptin (trastuzumab) therapy. Accurate assessment of HER2 status is critical to ensure that patients who may benefit from Herceptin target therapy are identified. There are plenty of antibodies used in diagnostic surgical pathology. Many clinical laboratories and hospitals maintain menus of over 200 antibodies used for clinical diagnostic, prognostic and predictive biomarkers, and many of the antibodies are applied on cancer diagnosis.

In sum, the present invention provides a 3D histopathology imaging method and system capable of reducing image losses. Further, the 3D histopathology imaging method and system as provided facilitate medical staffs on therapeutic decisions.

In sum, a 3D image is obtained from a tissue specimen through a microscopy (e.g., through laser scanning technology), in which the tissue specimen is stained and embedded. The 3D image is performed with an image slicing technology along three mutually perpendicular axes, to generate a plurality of 2D image on each of the axes. An antibody expression is calculated with respect to each axis. The calculation results may be provide to medical staffs, such as doctors, to help them to determine what therapeutic approached should be taken to treat the patient.

1. A three-dimensional (3D) histopathology imaging method, comprising:
collecting a tissue specimen from a subject;
staining the tissue so as to obtain a stained tissue;
obtaining, by a microscopy, a 3D image of the stained tissue; and
performing an imaging slicing procedure on the 3D image to generate a plurality of two-dimensional (2D) images.

2. The 3D histopathology imaging method of claim 1, wherein the step of staining the tissue further comprises embedding the stained tissue in an agarose gel or a hydrogel.

3. The 3D histopathology imaging method of claim 1, further comprising a step of:
clearing the tissue, after the step of collecting the tissue specimen.

4. The 3D histopathology imaging method of claim 1, wherein the microscopy performs a laser scan procedure to obtain the 3D image.

5. The 3D histopathology imaging method of claim 1, wherein in the image slicing procedure, the 3D image is sliced into different planes so as to generate the plurality of 2D images.

6. The 3D histopathology imaging method of claim 5, wherein the plurality of 2D images presents an antibody expression.

7. The 3D histopathology imaging method of claim 1, wherein in the image slicing procedure, the 3D image is sliced along an X-axis, a Y-axis and a Z-axis.

8. A 3D histopathology imaging system, comprising:
a microscopy, configured to obtain a 3D image of a tissue specimen; and
a processor, configured to perform an imaging slicing procedure on the 3D image to generate a plurality of 2D images;
wherein the tissue specimen is collected from a subject, and the tissue is stained and embedded.

9. The 3D histopathology imaging system of claim 8, wherein the stained tissue is embedded in an agarose gel or a hydrogel.

10. The 3D histopathology imaging system of claim 8, wherein the tissue specimen is treated with a tissue clearing procedure.

11. The 3D histopathology imaging system of claim 8, wherein the microscopy performs a laser scan procedure to obtain the 3D image.

12. The 3D histopathology imaging system of claim 8, wherein in the image slicing procedure, the 3D image is sliced into different planes so as to generate the plurality of 2D images.

13. The 3D histopathology imaging system of claim 12, wherein the plurality of 2D images presents an antibody expression.

14. The 3D histopathology imaging system of claim 8, wherein in the image slicing procedure, the 3D image is sliced along an X-axis, a Y-axis and a Z-axis.
